(19) United States
(12) Patent Application Publication
(10) Pub. No.: US 2022/0097298 A1
(43) Pub. Date: Mar. 31, 2022

(54) PRINTING HEAD ANNULARLY COATED WITH FIBER-REINFORCED COMPOSITE MATERIAL

(71) Applicant: BEIJING NATIONAL INNOVATION INSTITUTE OF LIGHTWEIGHT LTD., Beijing (CN)

(72) Inventors: Zhongde SHAN, Beijing (CN); Congze FAN, Beijing (CN); Li ZHAN, Beijing (CN); Feng LIU, Beijing (CN); Xiaojun LIU, Beijing (CN)

(73) Assignee: BEIJING NATIONAL INNOVATION INSTITUTE OF LIGHTWEIGHT LTD., Beijing (CN)

(21) Appl. No.: 17/418,163

(22) PCT Filed: Dec. 30, 2019
(86) PCT No.: PCT/CN2019/129706

§ 371 Date: Jun. 24, 2021

(30) Foreign Application Priority Data
Dec. 28, 2018 (CN) 201811619298.9

(51) Int. Cl. B29C 64/165; B29C 64/209; B29C 64/393

(52) U.S. Cl. CPC B29C 64/165; B33Y 50/02; B29C 64/393; B29C 64/209

(57) ABSTRACT

A printing head annularly coated with a fiber-reinforced composite material, comprising a feed part, an extrusion mechanism, an immersion chamber, an annularly coated nozzle, and a measurement and control part, wherein the feed part is mainly used for quantitatively providing a resin material at a constant speed, and the lower end of the feed part is connected with the extrusion mechanism; the resin is extruded out at the constant speed under the actions of a heating ring and a screw rod, and enters the immersion chamber; in the immersion chamber, the resin and a fiber are mixed, and are extruded and molded by means of the annularly coated nozzle. The bottom end of the annularly coated nozzle is of a planar structure, and after the composite material is molded, the molded surface of the composite material can be compacted.

The present application claims priority to Chinese Patent Application No. 2018116192989, titled “PRINTING HEAD ANNULARLY COATED WITH FIBER-REINFORCED COMPOSITE MATERIAL”, filed with the China National Intellectual Property Administration on Dec. 28, 2018, which is incorporated herein by reference in its entirety.

### FIELD

The present application belongs to the field of composite 3D printing (additive manufacturing), and relates to a printing head annularly coated with a fiber-reinforced composite material.

### BACKGROUND

3D printing (additive manufacturing) technology is a method of molding a three-dimensional component by stacking layers of materials. Compared with conventional subtractive manufacturing, this method not only improves the geometric accuracy of processing, but also greatly reduces the waste of materials. In addition, this method can further realize intelligent and digital processing and manufacturing, and improve the efficiency of the component trial production link.

A fiber-reinforced composite material has advantages of good mechanical and chemical properties, recyclability and low density, and it is widely used in the aviation industry and automobile manufacturing. Therefore, some scientific research institutions try to use 3D printing technology to complete the printing of the fiber-reinforced composite material. At present, the printing technology of a short fiber-reinforced composite material has matured day by day. However, the printing technology for molding a continuous fiber-reinforced composite material with a better property is still in the stage of exploration and research. In the conventional technology, continuous fiber and resin wire are respectively fed into the head, and the resin is heated and melted and then impregnated and mixed with the fiber. Due to the limit of the internal structure and thermal distribution of a nozzle, the infiltration effect of the fiber and the resin is poor, and the fiber may be easily dispersed and worn by the resin flow, which directly affects the mechanical property of the printed and molded member. In addition, the main material of the existing printing technology of the continuous fiber-reinforced composite material is a wire which needs to be pre-molded. The complicated molding process and the limited size of the wire directly restrict the further improvement of 3D printing efficiency. Therefore, it is urgent to develop a new type of printing head capable of adapting to the printing of pellets and powers and molding a fiber-reinforced composite material with an excellent mechanical property.

### SUMMARY

In order to overcome the disadvantages in the above technology, a printing head annularly coated with a fiber-reinforced composite material is provided according to the present application, which on the one hand realizes the rapid and efficient mixing of a resin and a fiber, removes the restriction on the form of a raw material, and improves the impregnation effect of the fiber and the resin; on the other hand, the compact printing of the fiber and the resin is realized, and the mechanical property of a molded member is improved.

In order to achieve the above objects, the following technical solutions are adopted by the present application.

A printing head annularly coated with a fiber-reinforced composite material includes a feeding part, an extrusion mechanism (3), an impregnation chamber (1), an annularly coated nozzle (2), and a measurement and control part (10), and finally the mixed printing function of a fiber and a resin is realized.

Further, the feeding part is configured to provide a stable quantitative transportation of resin pellets and powers, a bottom of the barrel (7) is fixed on the weighting module (8) by a bolt; the weighting module (8) is configured to monitor a mass of the resin inside the barrel (7) in real time and is configured to feed the mass back to a host computer; the weighting module (8) and the barrel (7) are mounted on a seat of the push rod mechanism (9) together, if the host computer sends out a feeding signal, the push rod mechanism (9) pushes the barrel (7) to tilt, and then a resin material is added into the hopper (6); a bottom end of the hopper (6) is connected to the extrusion mechanism (3) by a thread, and the resin material entering the hopper (6) is added into the screw (5) of the extrusion mechanism (3) to complete the feeding process.

Further, a principle of the extrusion mechanism (3) is that the screw (5) melts and pressurizes to extrude the extrusion mechanism (3), and a drive motor (12) is connected to the screw (5) through a reducer and a transmission structure (11) to drive the screw (5) to rotate; the screw (5) is arranged in the extrusion mechanism (3), and the heat is transferred from the heating ring (4) fixed on an outer wall of the extrusion mechanism (3) to the screw (5), a resin material at the screw (5) is melted and is extruded to an end under the rotation of the screw (5).

Further, the impregnation chamber (1) has a hollow structure with a spherical mixing zone (17) of the fiber (18) and the resin therein; the fiber (18) enters the mixing zone (17) through the annularly coated nozzle (2), the resin enters the mixing zone (17) under the action of the extrusion mechanism (3), and the resin and the fiber (18) are in contact and infiltrated in the mixing zone (17); a melt pressure sensor (14) is connected to the impregnation chamber (1) through a thread, and a surface of the melt pressure sensor (14) is in contact with the resin melt; a high-temperature melt metering structure (16) is arranged inside the impregnation chamber (1), which is configured to pressurize and stabilize the resin melt, and control a flow rate of the melt; the heating structure is arranged inside a hole on an outer wall of the impregnation chamber (1), and works with a temperature sensor to play a role of insulation and temperature control for the melt.

Further, the annularly coated nozzle (2) includes an inlet mold (19) and an outlet mold (20), both the inlet mold (19) and the outlet mold (20) are connected to the impregnation chamber (1) through threads, an opening size of the inlet mold (19) is related to a diameter of the fiber (18), and a size of the outlet mold (20) is related to the process of a molded member; the fiber (18) enters the mixing zone (17) through the inlet mold (19), and the resin forms an annularly coated zone in the mixing zone (17), in the annularly coated zone, a flow rate of the resin is stable, and the fiber (18) is not easy to be eroded in a horizontal direction and is not easy to wear; a bottom end of the outlet mold (20) has a plane structure, which is configured to compact a molding passage after the composite material is molded.

Further, the measurement and control part (10) includes temperature measurement, pressure measurement and flow rate measurement; temperatures of the extrusion structure, the impregnation chamber (1) and the annularly coated nozzle (2) are monitored by temperature sensors in real time, and the temperatures are controlled to be stable by the heating structure (15) and the heating ring (4); a melt pressure sensor (14) is configured to monitor a pressure of the resin in the mixing zone (17) in real time and feed the pressure back to a host computer; if the pressure suddenly changes or an abnormal signal occurs, the printing process is stopped by a control signal; a high-temperature melt metering structure (16) is configured to monitor a flow rate of the resin in the mixing zone (17) in real time, and realize the functions of pressurization and pressure stabilization to ensure the stable coating and printing for the resin flow.

Through the technical solutions of the present application, the following beneficial effects can be achieved.

For the problem that in the printing process of the existing fiber-reinforced composite material, the internal fiber of the head are easily dispersed and worn by the resin, and the mechanical property and molding accuracy of the molded member are still difficult to meet the needs, the used of the extrusion mechanism including the screw according to the present application has greatly improved the flow rate and flow of the resin melt. In addition, printing of the material state such as pellets and powders can be achieved, which eliminates the need for the molding link of the resin wire. Since there is a spherical mixing zone in the impregnation chamber, the mixing zone provides a stable impregnation environment for the fiber and the resin; the annularly coated nozzle keeps the fiber in a center of the resin flow, which reduces the dispersion effect of the resin on the fiber. The bottom end of the annularly coated nozzle is a platform, which can achieve compaction during the printing process, reduce the internal porosity of the molded member, and improves the mechanical property of the molded member. Finally, high-precision and high-efficiency printing of the molded member with excellent mechanical property is achieved.

### BRIEF DESCRIPTION OF THE DRAWINGS

The drawings of the specification constituting a part of the present application are used to provide a further understanding of the present application. The exemplary embodiments and descriptions of the present application are used to explain the present application, and do not constitute an improper limitation of the present application. In the drawings:

FIG. 1 is a schematic diagram showing the structure of a printing head according to the present application;

FIG. 2 is a schematic sectional view of an impregnation chamber (1) according to the present application;

FIG. 3 is a schematic diagram showing the structure and the position of an annularly coated nozzle (2) according to the present application;

FIG. 4 is a schematic diagram of an inlet mold (19) according to the present application;

FIG. 5 is a schematic diagram of an outlet mold (20) according to the present application.

### DETAILED DESCRIPTION OF THE EMBODIMENTS

The technical solutions according to the embodiments of the present application will be described clearly and completely as follows in conjunction with the drawings in the embodiments of the present application. It is apparent that the described embodiments are only a part of the embodiments according to the present application, rather than all of the embodiments. The following description of at least one exemplary embodiment is actually only illustrative, and in no way serves as any limitation to the present application and application or use of the present application. Based on the embodiments of the present application, all other obtained without creative efforts by those of the ordinary skill in the art shall fall within the protection scope of the present application.

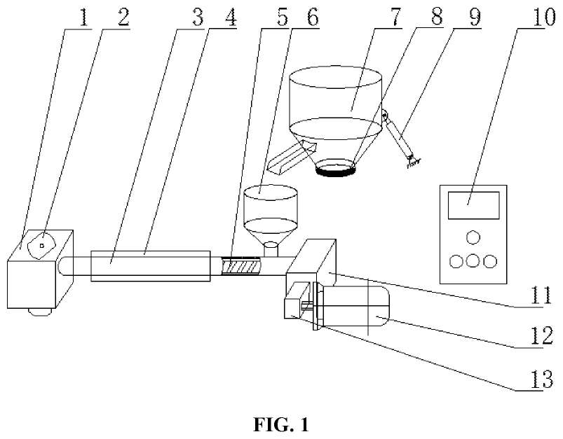

As shown in FIG. 1, a printing head annularly coated with a fiber-reinforced composite material includes a feeding part, an extrusion mechanism 3, an impregnation chamber 1, an annularly coated nozzle 2, and a measurement and control part 10, and finally the mixed printing function of a fiber and a resin is realized. The feeding part is partially connected to a screw 5 in the extrusion mechanism 3 through a hopper 6, and the extrusion mechanism 3 is fixed on a side of the impregnation chamber 1, so as to ensure the sealing of a resin melt. The impregnation chamber 1 includes the annularly coated nozzle 2 inside, and an inlet mold 19 and an outlet mold 20 of the annularly coated nozzle 2 are fixed in the impregnation chamber 1 by threads.

As shown in FIG. 1, during the printing process, the material is fed into the hopper 6, and a weighting module 8 is configured to feed back a mass signal to a host computer. The host computer controls a push rod mechanism 9 to transport the material to the hopper 6, and a resin material enters the extrusion mechanism 3 through the hopper 6. The screw 5 of the extrusion mechanism 3 is rotatable under the action of a drive motor 12, and delivers the resin material to a melting portion heated by the heating ring 4. After the resin is melted, the resin is delivered to a high-temperature melt metering structure 16, so as to realize the function of pressurization and pressure stabilization. The resin is infiltrated with the fiber 18 in the impregnation chamber 1, and is wrapped by the resin flow and printed and molded by the outlet mold 20.

As shown in FIG. 1, the feeding part is configured to provide a stable quantitative transportation of resin pellets and powers, a bottom of a barrel 7 is fixed on the weighting module 8 by a bolt. The weighting module 8 is configured to monitor a mass of the resin inside the barrel 7 in real time and feed the mass back to the host computer. The weighting module 8 and the barrel 7 are mounted on a seat of the push rod mechanism 9 together, if the host computer sends out a feeding signal, the push rod mechanism 9 pushes the barrel 7 to tilt, and then the resin material is added into the hopper 6. A bottom end of the hopper 6 is connected to the extrusion mechanism 3 by a thread, and the resin material entering the hopper 6 is added into the screw 5 of the extrusion mechanism 3 to complete the feeding process.

In an embodiment, the hopper can be fed by a vacuum feeding device inside the barrel 7, and the weighting module 8 can monitor the mass of the resin inside the barrel 7 in real time.

In an embodiment, the push rod mechanism 9 has various types, and it may be an electric push rod or an air cylinder, and the tilting and turnover of the barrel 7 are realized according to a control signal.

As shown in FIG. 1, a principle of the extrusion mechanism 3 is that the screw 5 melts and pressurizes to extrude, and the drive motor 12 is connected to the screw 5 through a reducer 13 and a transmission structure 11, so as to drive the screw 5 to rotate. The screw 5 is arranged inside the extrusion mechanism 3, and the heat is transferred from the heating ring 4 fixed on an outer wall of the extrusion mechanism 3 to the screw 5, a resin material at the screw 5 is melted and is extruded to an end under the rotation of the screw 5.

In an embodiment, in the extrusion mechanism 3, the type of the screw 5 can be selected according to requirements, and then a structure size and distribution position of the entire extrusion mechanism 3 can be designed. An interior of the screw 5 may include multiple temperature measurement points, so as to accurately grasp the temperature distribution of each position of the extrusion mechanism 3, and further optimize the process parameters.

As shown in FIG. 1, a structure of the printing head may be placed horizontally, or, by placing the extrusion mechanism 3 vertically, distribution positions of the feeding part and the impregnation chamber 1 may be correspondingly adjusted, thereby saving a printing space in a horizontal direction.

As shown in FIG. 1, the measurement and control part 10 includes temperature measurement, pressure measurement and flow rate measurement. Temperatures of the extrusion structure, the impregnation chamber 1 and the annularly coated nozzle 2 are monitored by temperature sensors in real time, and the temperatures are controlled to be stable by the heating structure 15 and the heating ring 4. A melt pressure sensor 14 is configured to monitor a pressure of the resin in a mixing zone 17 in real time and feed the pressure back to a host computer. If the pressure suddenly changes or an abnormal signal occurs, the printing process is stopped according to the control signal. A high-temperature melt metering structure 16 is configured to monitor a flow rate of the resin in the mixing zone 17 in real time, and realize the functions of pressurization and pressure stabilization, which ensures the stable coating and printing for the resin flow.

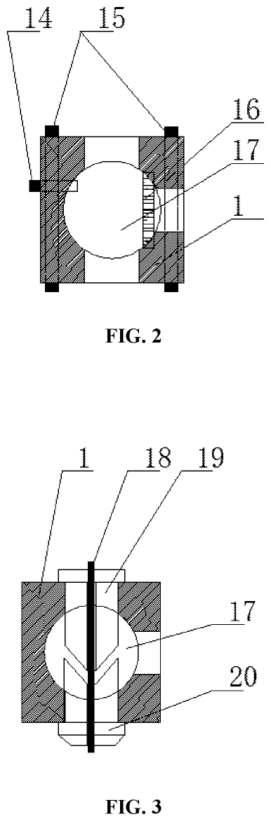

As shown in FIG. 2, the impregnation chamber 1 has a hollow structure with a spherical mixing zone 17 of the fiber 18 and the resin therein. The fiber 18 enters the mixing zone 17 through the annularly coated nozzle 2, the resin enters the mixing zone 17 under the action of the extrusion mechanism 3, and the resin and the fiber 18 are in contact and infiltrated in the mixing zone 17. A melt pressure sensor 14 is connected to the impregnation chamber 1 through a thread, and a surface of the melt pressure sensor 14 is in contact with the resin melt. A high-temperature melt metering structure 16 is arranged inside the impregnation chamber 1, which is configured to pressurize and stabilize the resin melt, and control a flow rate of the melt. The heating structure is arranged inside a hole on an outer wall of the impregnation chamber 1, and works with a temperature sensor to play a role of insulation and temperature control for the melt.

In an embodiment, an external structure of the impregnation chamber 1 may be of any shape, and it is only necessary to ensure that the flow rate and the pressure of the resin inside the mixing zone 17 are stable. The distribution position of the melt pressure sensor 14 can be randomly set, and it is only necessary to monitor the pressure of the resin flow close to the outlet. If the pressure is too high, the melt pressure sensor 14 feeds the pressure signal back to the host computer to stop the work of each part and realize the alarm function.

In an embodiment, the heating structure 15 is mainly used for stabilizing the temperature in the impregnation chamber 1, and the heating form may be electric heating, infrared heating, etc. The heating structure 15 works with the temperature sensor, so as to control the temperature.

As shown in FIG. 3, the annularly coated nozzle 2 includes the inlet mold 19 and the outlet mold 20, and both the inlet mold 19 and the outlet mold 20 are connected to the impregnation chamber 1 through threads. An opening size of the inlet mold 19 is related to a diameter of the fiber 18, and a size of the outlet mold 20 is related to the process of a molded member. The fiber 18 enters the mixing zone 17 through the inlet mold 19, and the resin forms an annularly coated zone in the mixing zone 17. In the annularly coated zone, a flow rate of the resin is stable, and the fiber 18 may not be easy to be eroded in a horizontal direction and is not easy to wear. A bottom end of the outlet mold 20 has a plane structure, which is configured to compact a molding passage after the composite material is molded.

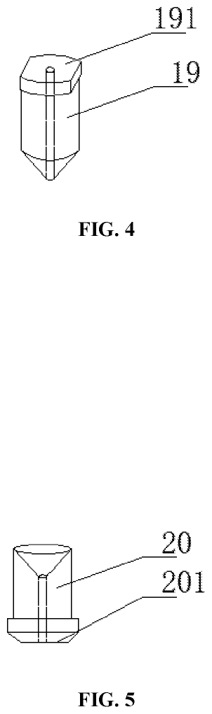

As shown in FIG. 4, the inlet mold 19 includes a structure 191 which facilitates mounting, so that a wrench can be placed at two ends to realize rapid rotation.

As shown in FIG. 5, the outlet mold 20 includes a structure of a bottom end 201, and the bottom end 201 is a plane with a certain area, which is configured to compact the molding passage after the composite material is molded.

In this embodiment, the resin mainly refers to thermoplastic resins such as polylactic acid (PLA), acrylonitrile-butadiene-styrene copolymer (ABS), polyimide (PI), polyether ether ketone (PEEK), etc., and the fiber 18 may be carbon fiber, glass fiber, or organic fiber of a variety of specifications such as 1K, 3K, 6K, and 12K.

It should be noted that, the terms used herein are only for describing specific embodiments, and are not intended to limit the exemplary embodiments according to the present application. As used herein, unless the context clearly indicates otherwise, the singular form is also intended to include the plural form. In addition, it should be understood that when the terms “comprise” and/or “include” are used in the specification, they indicate that there are features, steps, operations, devices, components and/or combinations thereof.

Unless specifically stated otherwise, the relative arrangement, numerical expressions and numeral values of the components and steps set forth in these embodiments do not limit the scope of the present application. In addition, it should be understood that, for ease of description, the sizes of the various parts shown in the drawings are not drawn in accordance with actual proportional relationships. The technologies, methods, and devices known to those skilled in the art in the relevant fields may not be discussed in detail, but in appropriate cases, the technologies, methods, and devices should be regarded as part of the authorized specification. In all examples shown and discussed herein, any specific value should be interpreted as merely exemplary, rather than as a limitation. Therefore, other examples of the exemplary embodiments may have different values. It should be noted that similar reference numerals and letters indicate similar items in the following drawings. Therefore, once an item is defined in one drawing, it does not need to be discussed further in subsequent drawings.

In the description of the present application, it needs to be understood that the location or position relationship indicated by the location words such as “front”, “rear”, “up”, “down”, “left”, “right”, “transverse”, “vertical”, “horizontal”, “top” and “bottom” etc. is generally based on the location or position relationship shown in the drawings, only for the convenience of describing the present application and simplifying the description. In the absence of a contrary description, these location words do not indicate or imply that the device or element referred to must have a specific location or be constructed and operated in a specific location. Therefore, the location words cannot be understood as a limitation on the protection scope of the present application. The location words of “in” and “out” refer to the interior and outside relative to the contour of each component itself.

In order to facilitate description, spatial relative terms such as “above”, “over”, “on an upper surface . . . ”, “upper”, etc., can be used herein to describe the spatial position relationship between a device or feature and other devices or features as shown in the drawings. It should be understood that the spatial relative terms are intended to include different locations in use or operation in addition to the locations of the device described in the drawing. For example, if the device in the drawing is inverted, then a device described as “above other devices or configurations” or “over other devices or configurations” will be positioned as “below other devices or configurations” or “under other devices or configurations”. Therefore, the exemplary term “above” may include two locations of “above” and “below”. The device can also be positioned in other different ways (rotate by 90 degrees or in other locations), and the relative description of the space used here can be explained accordingly.

In addition, it should be noted that the use of terms such as “first” and “second” to define components is only for the convenience of distinguishing the corresponding the corresponding components. Unless otherwise stated, the above terms have no special meaning, and therefore cannot be understood as limitation on the protection scope of the present application.

It should be noted that, the terms used here are only for describing of specific embodiment, and are not intended to limit the exemplary embodiments according to the present application. As used herein, unless the context clearly indicates otherwise, the singular form is also intended to include the plural form. In addition, it should be understood that when the terms “comprise” and/or “include” are used in the specification, they indicate that there are features, steps, operations, devices, components and/or combinations thereof.

It should be noted that the terms of “first” and “second” in the specification and the above drawings are used to distinguish similar objects, rather than describing a specific order or sequence. It should be noted that the data used in this way can be interchanged under appropriate circumstances, so that the embodiments of the present application described herein can be implemented in a sequence other than those illustrated or described herein.

The above descriptions are only preferred embodiments of the present application and are not used to limit the present application. For those skilled in the art, the present application may have various modifications and changes. Any modification, equivalent replacement, improvement, etc., made within the spirit and principle of the present application should be included in the protection scope of the present application.

1. A printing head annularly coated with a fiber-reinforced composite material, comprising a feeding part, an extrusion mechanism, an impregnation chamber, an annularly coated nozzle, and a measurement and control part, wherein the feeding part comprises a weighable barrel, a push rod mechanism for assisting the barrel to pouring a material, a weighting module for monitoring a weight and a hopper which is connected to the extrusion mechanism; the extrusion mechanism comprises a drive motor for providing rotating power, a heating ring for providing a constant temperature and a screw for providing extrusion power; the impregnation chamber comprises a mixing zone for a fiber and a resin, a heating structure, a high-temperature melt metering structure which provides a stable resin flow, and a related measurement and control structure which is configured to detect a pressure and a temperature of a melt; the annularly coated nozzle comprises an inlet mold and an outlet mold, and is fixed in the impregnation chamber at a distance, which allows the resin flow to be annularly coated around the fiber to produce two effects of beam type and impregnation, a bottom end of the outlet mold of the nozzle is a plane, which is configured to compact the composite material after the composite material is molded.

2. The printing head annularly coated with the fiber-reinforced composite material according to claim 1, wherein the feeding part is configured to provide a stable quantitative transportation of resin pellets and powers, a bottom of the barrel is fixed on the weighting module by a bolt; the weighting module is configured to monitor a mass of the resin inside the barrel in real time and is configured to feed the mass back to a host computer; the weighting module and the barrel are mounted on a seat of the push rod mechanism together, if the host computer sends out a feeding signal, the push rod mechanism pushes the barrel to tilt, and then a resin material is added into the hopper; a bottom end of the hopper is connected to the extrusion mechanism by a thread, and the resin material entering the hopper is added into the screw of the extrusion mechanism to complete the feeding process.

3. The printing head annularly coated with the fiber-reinforced composite material according to claim 1, wherein a principle of the extrusion mechanism is that the screw melts and pressurizes to extrude the extrusion mechanism, and the drive motor is connected to the screw through a reducer and a transmission structure to drive the screwy to rotate; the screw is arranged in the extrusion mechanism, and heat is transferred from the heating ring fixed on an outer wall of the extrusion mechanism to the screw, a resin material at the screw is melted and is extruded to an end under the rotation of the screw.

4. The printing head annularly coated with the fiber-reinforced composite material according to claim 1, wherein the impregnation chamber has a hollow structure with a spherical mixing zone of the fiber and the resin therein; the fiber enters the mixing zone through the annularly coated nozzle, the resin enters the mixing zone under the action of the extrusion mechanism, and the resin and the fiber are in contact and infiltrated in the mixing zone; a melt pressure sensor is connected to the impregnation chamber through a thread, and a surface of the melt pressure sensor is in contact with the resin melt; the high-temperature melt metering structure is arranged inside the impregnation chamber, which is configured to pressurize and stabilize the resin melt, and control a flow rate of the melt; the heating structure is arranged inside a hole on an outer wall of the impregnation chamber, and works with a temperature sensor to play a role of insulation and temperature control for the melt.

5. The printing head annularly coated with the fiber-reinforced composite material according to claim 1, wherein the annularly coated nozzle comprises the inlet mold and the outlet mold, both the inlet mold and the outlet mold are connected to the impregnation chamber through threads, an opening size of the inlet mold is related to a diameter of the fiber, and a size of the outlet mold is related to the process of a molded member; the fiber enters the mixing zone through the inlet mold, and the resin forms an annularly coated zone in the mixing zone, in the annularly coated zone, a flow rate of the resin is stable, and the fiber is not easy to be eroded in a horizontal direction and is not easy to wear; a bottom end of the outlet mold has a plane structure, which is configured to compact a molding passage after the composite material is molded.

6. The printing head annularly coated with the fiber-reinforced composite material according to claim 1, wherein the measurement and control part comprises temperature measurement, pressure measurement and flow rate measurement; temperatures of the extrusion structure, the impregnation chamber and the annularly coated nozzle are monitored by temperature sensors in real time, and the temperatures are controlled to be stable by the heating structure and the heating ring; a melt pressure sensor is configured to monitor a pressure of the resin in the mixing zone in real time and feed the pressure back to a host computer; if the pressure suddenly changes or an abnormal signal occurs, the printing process is stopped by a control signal; the high-temperature melt metering structure is configured to monitor a flow rate of the resin in the mixing zone in real time, and realize the functions of pressurization and pressure stabilization, which ensures the stable coating and printing for the resin flow.

7. The printing head annularly coated with the fiber-reinforced composite material according to claim 1, wherein a structure of the printing head is placed horizontally, or, by placing the extrusion mechanism vertically, distribution positions of the feeding part and the impregnation chamber are correspondingly adjusted, which saves a printing space in a horizontal direction.
